(19) United States
(12) Patent Application Publication
(10) Pub. No.: US 2026/0297386 A1
(43) Pub. Date: Oct. 1, 2026

(54) USE OF A TERTIARY AMINE TO IMPROVE THE PROPERTIES OF A CHEMICAL ANCHOR

(71) Applicant: Hilti Aktiengesellschaft, Schaan (LI)

(72) Inventor: Ana-Maria Martin-Lasanta, Giessen (DE)

(73) Assignee: Hilti Aktiengesellschaft, Schaan (LI)

(21) Appl. No.: 19/480,232

(22) PCT Filed: Apr. 19, 2024
(86) PCT No.: PCT/EP2024/060754

§ 371 Date: Oct. 30, 2025

(30) Foreign Application Priority Data
May 5, 2023 (EP) 23171925.3

(51) Int. Cl. C09J 5/00; C09J 11/06; C09J 163/00

(52) U.S. Cl. CPC C09J 5/00; C09J 11/06; C09J 163/00

(57) ABSTRACT

Use of a tertiary amine to improve the properties of a chemical anchor The present invention relates to the use of at least one tertiary amine in a chemical anchor. The at least one tertiary amine is selected from the group consisting of 2,4,6-tris[(di(C₁-C₆-alkyl)amino-(C₁-C₆-alkylidene)]phenols, 1,3,5-tris[(di(C₁-C₆-alkyl)amino-(C₁-C₆-alkylidene)]hexahydro-1,3,5-triazine, and any mixtures of two or more thereof. This specific at least one tertiary amine reduces the creep behavior of a chemical anchor at a substrate temperature of about 30° C. to about 90° C. compared to a chemical anchor which has a lower proportion of the at least one tertiary amine, or does not contain the at least one tertiary amine.

The present invention relates to the use of at least one tertiary amine in a chemical anchor. The at least one tertiary amine is selected from the group consisting of 2,4,6-tris[(di(C₁-C₆-alkyl)amino-(C₁-C₆-alkylidene)]phenols, 1,3,5-tris[(di(C₁-C₆-alkyl)amino-(C₁-C₆-alkylidene)]hexahydro-1,3,5-triazine, and any mixtures of two or more thereof. This specific at least one tertiary amine reduces the creep behavior of a chemical anchor at a substrate temperature of about 30° C. to about 90° C. compared to a chemical anchor which has a lower proportion of the at least one tertiary amine, or does not contain the at least one tertiary amine.

In the construction industry, resin systems are used for the chemical fastening of construction elements such as anchor rods, reinforcing bars and screws in cavities, such as boreholes or gaps in buildings. Resin systems of this kind are also referred to as “chemical anchors.”

These resin systems can be provided as a homogeneous resin composition or as a system made up of a plurality components. Usually, resin systems are commercially available as a multi-component resin system. A multi-component resin system is understood to mean a resin system having a plurality of components, typically two components (two-component resin system), with (i) at least one resin component (A) and (ii) at least one curing agent component (B), and optionally further separate components. The components are in separate containers so that they do not come into contact with one another during storage and cannot react with one another before application. For the intended use of a multi-component resin system, the components (A) and (B), and in some cases further components, are mixed at the desired site of use so that the curing reaction can take place there.

For storage before use, cartridges are suitable which are, for example, made of plastic, ceramic or glass, in which cartridges the components are arranged separately from one another by destructible partition walls or integrated separate destructible containers, for example as cartridges nested in one another, preferably two-chamber cartridges, and in particular multi-component or preferably two-component cartridges, in the chambers of which the components (A) and (B) of a two-component resin system are contained. By destroying the delimitations in the cartridges or discharging the cartridges by, for example, a static mixer, the two or more components are mixed. As a result, a curing reaction, i.e., polymerization, is initiated and the resin is cured.

By mixing the two or more components for the intended use as a chemical anchor, a mixture is created which then cures to form a chemically crosslinked composite material. The resulting hardened material, i.e., the cured chemical anchor, is typically very strong and demonstrates high strength and the ability to transfer stresses to the substrate, while maintaining the structural integrity of the chemical anchor even under loads.

Chemical anchors are typically cured at the desired place of use at the ambient temperatures prevailing in the substrate. Since chemical anchors are typically used in the construction industry, the ambient temperatures correspond to the outside temperatures. These usually move within a range from around −10° C. to around 60° C. Depending on solar radiation and other influences, significantly higher temperatures in the substrate are also possible, for example from around 40° C. to around 90° C.

The mechanical properties of chemical anchors can be affected by the ambient temperature. Even a rise in temperature during the curing reaction can lead to a considerable reduction in the load-bearing capacity of the subsequently cured chemical anchor.

The chemical anchor is also repeatedly exposed to fluctuating temperatures during its lifetime. In particular, the occurrence of elevated temperatures over a longer period of time can impair the load-bearing capacity of a chemical anchor. Even strongly fluctuating short-term substrate temperatures, but especially substrate temperatures elevated over the long-term, can have an unfavorable effect on the material properties of a chemical anchor during its service life.

In particular, so-called “creep”, i.e., the deformation of a chemical anchor, increasingly occurs. For example, a chemical anchor can move slowly or become permanently deformed within a period of just a few hours at an elevated substrate temperature of around 30° C. to around 90° C. under the influence of sustained mechanical stress, such as continuous loads.

With increasing global warming, higher ambient temperatures in the substrate caused by strong solar radiation can also be expected in the construction industry in the future, and they can cause the substrate to heat up to a substrate temperature of around 40° C. or more, depending on the outside temperature and weather conditions. Multi-component resin systems which are described in the state of the art are often unable to meet these challenges.

In order to counteract the tendency of chemical anchors to creep, the development of new multi-component resin systems for use at elevated temperatures, in particular from around 40° C. to around 90° C., is desirable.

A frequently used multi-component resin system for a chemical anchor is an epoxy-amine-based system. In such a multi-component resin system, the resin component (A) contains at least one curable epoxy resin, and the curing agent component (B) contains at least one epoxy-reactive amine for curing the epoxy resin.

Typically, epoxy-amine systems include other common ingredients such as reactive diluents, fillers, rheology additives, accelerators, inhibitors and/or solvents which may be present in one or both components (A) and/or (B). Furthermore, they may in some cases also contain specific fillers which can contribute to solidification, even by hydraulic setting, as in the case of cement.

However, it is known that the epoxy-amine systems described in the prior art exhibit a significant deterioration in mechanical properties at elevated temperatures, i.e., temperatures above 20° C., but in particular from about 40° C. upwards. As described above, this deterioration often consists of a reduction in long-term stability under permanent load, which can lead to deformation of the chemical anchor and, as a result, even to displacements in the building substance fastened by the chemical anchor.

It is also known that the deterioration of the mechanical properties of materials is related to their glass transition temperature (Tg). Chemical anchors based on epoxy-amine systems generally have a comparatively low Tg. Therefore, epoxy-amine systems often tend to creep when the substrate temperature is elevated.

The primary and secondary amines contained in epoxy-amine-based resin systems are often labeled as “corrosive” (GHS05), which causes problems for the user in handling and possibly the need for protective equipment.

Accordingly, one of the tasks underlying the invention is to provide a two-component resin system which, when used as a chemical anchor, exhibits improved creep behavior at an elevated substrate temperature, for example from about 30° C. to about 90° C.

A further task underlying the invention is to provide a two-component resin system for a chemical anchor which, after curing, has a high compressive strength, for example above about 110 MPa. A further object underlying the invention is based is to provide a two-component resin system for a chemical anchor which has a high glass transition temperature, for example above about 70° C.

A further object underlying the invention is therefore to provide an environmentally friendly two-component resin system for use as a chemical anchor, with primary or secondary amines not being used in the curing agent component (B) thereof.

The objects underlying the invention are achieved by the uses defined in the independent claims. Preferred embodiments of the invention are defined in the dependent claims, the features of which can be freely combined with one another, unless otherwise stated.

An object of the invention is the use of at least one tertiary amine to reduce the creep of a cured chemical anchor at a substrate temperature of about 30° C. to about 90° C. as compared to a chemical anchor that contains a lower amount of the at least one tertiary amine or does not contain the at least one tertiary amine. The cured chemical anchor is prepared by mixing components (A) and (B) of a two-component resin system and then curing, wherein the two-component resin system consists of: (i) a resin component (A) comprising at least one curable epoxy resin, and (ii) a curing agent component (B) comprising the at least one tertiary amine. In this resin system, the tertiary amine acts as an accelerator for the curing of the epoxy resin. The at least one tertiary amine is selected from the group consisting of 2,4,6-tris[(di(C₁-C₆-alkyl)amino-(C₁-C₆-alkylidene)]phenols, 1,3,5-tris[(di(C₁-C₆-alkyl)amino-(C₁-C₆-alkylidene)]hexahydro-1,3,5-triazine, and any mixtures of two or more thereof. In a preferred embodiment, it is selected from the group consisting of tris[(di(C₁-C₆-alkyl)amino-(C₁-C₆-alkylidene)]phenols and any mixtures of two or more thereof. In a further preferred embodiment, it is selected from the group consisting of 2,4,6-tris[(dimethylaminomethyl)phenol and 1,3,5-tris-[3-(dimethylamino)propyl]-hexahydro-1,3,5-triazine and any mixtures thereof.

The proportion of the at least one tertiary amine in the resin composition arising from mixing the two components (A) and (B) is from about 3 wt % to about 20 wt %, preferably from about 4 wt % to about 15 wt %, with reference to the at least one curable epoxy resin.

The two-component resin system used in the invention (also referred to herein as a “two-component epoxy resin system”) does not comprise any primary or any secondary amine.

A further object of the invention is the use of the same two-component resin system, which comprises at least one tertiary amine as defined above, as a chemical anchor for fastening structural elements and anchoring means in cavities, such as holes or gaps in a substrate such as a structural substrate. The chemical anchor resulting from this use can support loads at a substrate temperature of about 30° C. to about 90° C. after curing of the resin composition, and exhibits improved creep behavior compared to chemical anchors with a lower content or no content of the tertiary amine as defined above.

The two-component resin system for the uses as a chemical anchor according to the invention comprises: (i) a resin component (A) comprising at least one curable epoxy resin, and (ii) a curing agent component (B) comprising the at least one tertiary amine. The two-component resin system does not contain any primary or secondary amine.

Surprisingly, it was found that the use of a specific at least one tertiary amine in a two-component epoxy resin system in a proportion of from about 3 wt % to about 20 wt %, preferably from about 4 wt % to about 15 wt %, relative to the at least one curable epoxy resin, in the absence of primary and secondary amines, improves the creep behavior of a chemical anchor at a substrate temperature from about 30° C. to about 90° C. compared to a chemical anchor that contains a lower proportion of the at least one tertiary amine or no proportion of the at least one tertiary amine.

It is therefore essential to the invention that the proportion of the at least one tertiary amine in the resin composition arising by mixing the two components (A) and (B) is from about 3 wt % to about 20 wt %, preferably from about 4 wt % to about 15 wt %, more preferably from about 5 wt % to about 10 wt %, relative to the at least one curable epoxy resin.

In addition, it was surprisingly found that a two-component epoxy resin system comprising at least one such tertiary amine is suitable in principle as a chemical anchor and has advantageous properties, particularly at a substrate temperature of about 30° C. to about 90° C.

Within the context of the invention, the terms used above and in the following description have the following meanings:
“Two-component resin system” denotes a resin system that comprises two separately-stored components, wherein the resin system comprises at least one resin component (A) and at least one curing agent component (B) so that curing takes place only after all components have been mixed.
“Epoxy resin composition” denotes a reactive composition comprising a curable epoxy resin and a suitable curing agent for the curable epoxy resin. According to the invention, this is typically obtained by mixing the resin component (A) and the curing agent component (B) and is subsequently used for chemical fastening.
“Curable epoxy resin” denotes a resin which contains reactive epoxide groups which can be reacted with a suitable curing agent to form a cured resin in a polymerization reaction, wherein an epoxide group, also referred to as glycidyl group, is a cyclic ether having a triatomic ring.
“Mean epoxide functionality” describes the averaged number of reactive epoxide groups of one or a mixture of a plurality of curable epoxy resins per molecule.
“Substrate temperature” denotes the temperature of the substrate on the contact surface for the epoxy resin composition to be cured. The substrate temperature is a function of the ambient temperature, typically the outside temperature in the construction industry, as well as of possible heating due to solar radiation. Heating is also possible using an external heat supply from artificial heat sources such as a heating block or fan heater. The substrate temperature can be determined using an infrared thermometer. Short-term increases in substrate temperatures are those that occur at short intervals, e.g., as a result of daily cycles. A long-term elevated substrate temperature is defined as an elevated average substrate temperature over longer periods of time (such as weeks and months). The substrate temperature can be determined, for example, using an infrared thermometer on the surface of the substrate.
“Amines” are compounds that are derived from ammonia by replacing one, two or three hydrogen atoms with hydrocarbon groups and which have the general structures RNH₂ (primary amine), R₂NH (secondary amine) and R₃N (tertiary amine).
“Chemical anchor” denotes a curable resin composition, in the context of the present invention a curable epoxy resin compound for the chemical fastening of construction elements and anchoring means in a cavity, in particular a (bore) hole or gap in various substrates, in particular structural substrates (such as masonry, concrete). After the curing reaction, a firm bond to the substrate is formed. Preferred applications are in the construction sector, for example for fastening anchor rods, anchor bolts, (threaded) rods, (threaded) sleeves, reinforced concrete rods or screws in masonry or concrete.
“Creep behavior” describes the plastic deformation, displacement or movement of a chemical anchor as a result of the impact of sustained loading, so-called continuous load. The creep behavior is mainly influenced by two factors: (i) sustained high loads, and (ii) increased temperature. The creep behavior can be determined as described in the exemplary embodiments.
“Lower proportion” is a 10% lower proportion, in a preferred embodiment a 50% lower proportion, compared to the reference proportion. In a specific, preferred embodiment, “lower proportion of” also means “in the absence of”.
“Aliphatic compounds” are acyclic or cyclic, saturated or unsaturated carbon compounds, excluding aromatic compounds.
“Aromatic compounds” are cyclic hydrocarbon compounds which follow Hückel's rule (4n+2).
“Alicyclic compounds” are aliphatic compounds having a carbocyclic ring structure, excluding benzene derivatives or other aromatic systems.
“poly”, “Poly” as a prefix means that two or more of the groups following this prefix are contained in a compound.
The article “a” or “an” as an article preceding a class of chemical compounds, e.g., preceding the word “filler,” means that one or more compounds included in this class of chemical compounds, e.g., various “fillers,” may be meant; in a preferred embodiment, this term means “one” numerically.
“At least one” means “one or more” numerically; in a preferred embodiment, this term means “one” numerically.
“About” before a numerical value allows a deviation of ±10%, in a preferred embodiment ±5%, in a highly preferred embodiment ±1% of this numerical value, in the most preferred embodiment “about” means exactly this numerical value, i.e., a deviation of ±0%.
“Contain”, “comprise” and “include” mean that more constituents may be present in addition to the aforementioned constituents; these terms are meant to be inclusive and therefore also include “consist of”; “consist of” is meant conclusively and means that no further constituents may be present; in a preferred embodiment, the terms “contain”, “comprise” and include mean the term “consist of”.

Unless stated otherwise, all standards cited in this text (e.g., DIN standards) were used in the version that was current on the filing date of this application. All trade names corresponding to the products available under these trade names at the time of filing the present application.

As explained above, the invention provides for the use of a two-component resin system as a chemical anchor. In the following, the constituents of the components (A) and (B) of a two-component resin system used in the invention are explained in more detail.

### Curable Epoxy Resin

The resin component (A) of a two-component resin system which is used according to the invention comprises at least one curable epoxy resin. In the context of the invention, it is therefore also referred to as the “epoxy resin component”.

A plurality of compounds known to a person skilled in the art and commercially available for this purpose, on an individual basis or in any desired mixtures with one another, can be considered as the at least one curable epoxy resin in the resin component (A).

An epoxy resin usable in accordance with the invention can be both saturated and unsaturated and have aliphatic, alicyclic, aromatic or heterocyclic and also have hydroxyl groups. Furthermore, such substituents may be contained which do not cause any interfering side reactions under the mixing or reaction conditions according to the invention, for example alkyl or aryl substituents, ether groups and the like. Trimeric and tetrameric epoxides are also suitable within the scope of the invention. Epoxy resins are preferably present in liquid form and generally have an average molecular weight of MW≤2000 g/mol.

The curable epoxy resin preferably has a mean epoxide functionality of about 1.5 or greater, more preferably about 2 or greater, even more preferably from about 2 to about 10, yet even more preferably from about 2 to about 3, most preferably about 2.

Curable epoxy resin used in the present invention can have an epoxy equivalent weight (EEW) of from about 120 to about 2000 g/EQ, preferably from about 140 to about 400 g/EQ, in particular from about 155 to about 300 g/EQ, very particularly from 158 to 290 g/EQ. Particularly preferred are curable epoxy resins with the EEWs indicated in the embodiments.

Preferably, the at least one curable epoxy resin is a glycidyl ether derived from a polyhydric alcohol, in particular a polyhydric phenol, such as bisphenol and novolac. Examples of such suitable epoxy resins are compounds selected from the group of diglycidyl ethers on the basis of resorcin, hydroquinone, 2,2-bis-(4-hydroxyphenyl)propane (bisphenol A), isomeric mixtures of dihydroxyphenylmethane (bisphenol F), tetrabromobisphenol A, novolacs, 4,4′-dihydroxyphenylcyclohexane, and 4,4′-dihydroxy-3,3′-dimethyldiphenylpropane. Particularly preferred are curable epoxy resins selected from the group of the diglycidyl ethers based on bisphenol A and bisphenol F and mixtures thereof, in particular the mixtures used in the exemplary embodiments.

A preferred example of a commercially available bisphenol F-based epoxy resin, comprising bisphenol F diglycidyl ether, is Araldite GY 282. An example of a commercially available bisphenol-A-based epoxy resin, comprising bisphenol A diglycidyl ether, is Araldite GY 240.

In a further preferred embodiment, the at least one curable epoxy resin is an epoxy resin produced from renewable sources. Such epoxy resins from renewable sources are, for example, isosorbide diglycidyl ether (CAS 13374-44-2), limonene-1,2:8,9-dioxide (LDO, CAS 96-08-2), vanillin diglycidyl ether (DGEVA, CAS 1584677-14-4), phloroglycinol triglycidyl ether (PTHE, CAS 4223-14-7), vanillic acid bisepoxide (CAS 1393710-63-8), and epoxidized vegetable oil, such as epoxidized castor oil (CAS 105839-17-6, commercially available as Erisys GE 35-H from Huntsman, Belgium) and epoxidized cardanol oil (mixture comprising, inter alia, CAS 1260636-34-7 and CAS 63284-28-6). In addition to Erisys GE 35-H, examples of bio-based polyepoxides commercially available in relatively large amounts which can be used within the scope of the invention are also Erisys GE 60 and GE 61 (epoxy resin based on sorbitol, Huntsman, Belgium) and Araldite DY-S (epoxy resin based on polyglycerol, Huntsman, Belgium).

The proportion of the at least one curable epoxy resin in the resin component (A) is >0 to 100 wt %, preferably from about 20 to about 90 wt %, more preferably from about 30 to about 85 wt %, and particularly preferably from about 40 to about 80 wt %, relative to the total weight of the resin component (A).

The proportion of the at least one curable epoxy resin after mixing components (A) and (B) is about 30 wt % to about 70 wt % relative to the total weight of the components (A) and (B) mixed together, preferably about 40 wt % to about 65 wt % relative to the total weight of the components (A) and (B) mixed together.

### Tertiary Amine

The curing agent component (B) of a two-component resin system for use according to the invention comprises at least one tertiary amine selected from the group consisting of 2,4,6-tris[(di(C₁-C₆-alkyl)amino-(C₁-C₆-alkylidene)]phenols, 1,3,5-tris[(di(C₁-C₆-alkyl)amino-(C₁-C₆-alkylidene)]hexahydro-1,3,5-triazine and any mixtures of two or more thereof.

In a preferred embodiment, the at least one tertiary amine is selected from the group consisting of tris[(di(C₁-C₆-alkyl)amino-(C₁-C₆-alkylidene)]phenols and any mixtures of two or more thereof.

In a further preferred embodiment, the at least one tertiary amine is selected from the group consisting of 2,4,6-tris[(dimethylaminomethyl)phenol and 1,3,5-tris-[3-(dimethylamino)propyl]-hexahydro-1,3,5-triazine and any mixtures thereof.

In a particularly preferred embodiment, the at least one tertiary amine is 2,4,6-tris(dimethylaminomethyl)phenol.

2,4,6-tris-(dimethylaminomethyl)phenol is commercially available under the trade name Ancamine® K54, and 1,3,5-tris[3-(dimethylamino)propyl]hexahydro-1,3,5-triazine is commercially available under the trade name Lupragen® N600. Commercially available technical grade Ancamine® K54 can contain 2,4,6-tris(di-C₂-C₆-alkylamino)phenol, 2,4,6-tris(dimethylamino)phenol and/or bis[(dimethylamino)methyl]phenol as impurities.

In a particularly preferred embodiment, 2,4,6-tris(dimethylaminomethyl)phenol is used for the use according to the invention to improve the creep behavior of a chemical anchor.

The proportion of the at least one tertiary amine in the resin composition arising by mixing the two components (A) and (B) is from about 3 wt % to about 20 wt %, preferably from about 4 wt % to about 15 wt %, more preferably from about 5 wt % to about 10 wt % relative to the at least one curable epoxy resin.

### Further Constituents of Components (A) and (B)

Both the resin component (A) and the curing agent component (B) and both components (A) and (B) typically comprise, in addition to the curable epoxy resin or the at least one tertiary amine, at least one further constituent. Other common components are, in particular, reactive diluents, fillers, rheology additives (thixotropic agents), adhesion promoters and solvents.

Depending on the desired effect of a further constituent, it may be preferred that the at least one further constituent is contained only in the resin component (A), only in the curing agent component (B), or in both components.

### Reactive Diluent

In one embodiment, the resin component (A) and/or the curing agent component (B), preferably at least the resin component (A), can contain at least one reactive diluent. Glycidyl ethers of aliphatic, alicyclic or aromatic monoalcohols or in particular polyalcohols, which have a lower molecular mass and viscosity than the curable epoxy resins described further above, are used as reactive diluents.

Examples of suitable reactive diluents are monoglycidyl ethers, e.g., o-cresyl glycidyl ether, and glycidyl ethers having an epoxide functionality of at least 2, such as 1,4-butanediol diglycidyl ether (BDDGE), cyclohexanedimethanol diglycidyl ether and hexanediol diglycidyl ether (HDDGE), as well as tri- or higher glycidyl ethers, such as glycerol triglycidyl ether, pentaerythritol tetraglycidyl ether, trimethylolpropane triglycidyl ether (TMPTGE), or trimethylolethane triglycidyl ether (TMETGE), with BDDGE, HDDGE, trimethylolpropane triglycidyl ether and trimethylolethane triglycidyl ether being preferred. Mixtures of two or more of these reactive diluents can also be used, preferably mixtures containing triglycidyl ethers, particularly preferably as a mixture of 1,4-butanediol diglycidyl ether (BDDGE) and trimethylolpropane triglycidyl ether (TMPTGE), or of 1,4-butanediol diglycidyl ether (BDDGE) and trimethylolethane triglycidyl ether (TMETGE).

The reactive diluents used in the examples and the mixtures thereof used therein are particularly preferred.

The at least one reactive diluent, when present, is preferably in a proportion of >0 to about 30 wt % relative to the total weight of the component in which the reactive diluent is contained (for example the resin component (A)), in particular in a proportion of about 10 to about 25 wt % relative to the total weight of the component.

### Fillers

Both the resin component (A) and the curing agent component (B), as well as both components (A) and (B) can contain at least one filler. It is preferable for both the resin component (A) and the curing agent component (B) to each contain at least one filler.

Preferably inorganic fillers, in particular quartz, aluminum oxides, glass, corundum, porcelain, stoneware, barite, light spar, gypsum, talcum, cements (such as Portland cement or aluminate cement), and/or chalk, and mixtures thereof serve as the fillers. The inorganic fillers can be added in the form of particles (for example in the form of powders, sands, or flours) or molded bodies (the latter preferably in the form of fibers or balls). A suitable selection of the fillers with regard to type and particle size distribution, particle size or (fiber) length can be used to control properties relevant to the application, such as rheological behavior, press-out forces, internal strength, tensile strength, pull-out forces, and impact strength.

Particularly suitable fillers are quartz powders, fine quartz powders, and ultra-fine quartz powders that have not been surface-treated, such as Millisil W3, Millisil W6, Millisil W8 and Millisil W12, preferably Millisil W12. Silanized quartz powders, fine quartz powders, and ultra-fine quartz powders can also be used. These are commercially available, for example, as the Silbond product series from Quarzwerke. The Silbond EST product series (treated with epoxysilane) and Silbond AST 25 (treated with aminosilane) are particularly preferred. Furthermore, it is possible for fillers based on aluminum oxide such as ultra-fine aluminum oxide fillers of the ASFP type from the company Denka, Japan (d₅₀=0.3 μm) or grades such as DAW or DAM with the type designations 45 (d₅₀<0.44 μm), 07 (d₅₀>8.4 μm), 05 (d₅₀<5.5 μm), and 03 (d₅₀<4.1 μm) to be used. Moreover, the surface-treated fine and ultra-fine fillers of the Aktisil AM 30 type (treated with aminosilane, d₅₀=2.2 μm) and Aktisil EM (treated with epoxysilane, d₅₀=2.2 μm) from Hoffman Mineral can be used. The fillers can be used individually or in any mixture with one another. Particularly preferred is quartz powder that has not been surface-treated, in particular Millisil W12.

The proportion of fillers in the resin component (A) is preferably from about 1 to about 60 wt %, more preferably from about 15 to about 45 wt %, relative to the total weight of the resin component (A). The proportion of fillers in the curing agent component (B) is preferably from approximately 1 to about 50 wt %, more preferably from about 5 to about 40 wt %, relative to the total weight of the curing agent component (B).

When at least one filler is present, the total filling level of an epoxy resin composition made up of components (A) and (B) is in a range from >0 to about 60 wt %, preferably in a range from about 10 to about 55 wt %, more preferably in a range from about 30 to about 50 wt %. The total filling level of the epoxy resin composition relates to the percentage by weight of all available fillers relative to the total weight of component (A) and component (B).

### Rheology Additives

Further optional constituents are rheological additives for adjusting the flow properties. Suitable rheological additives are:

In one embodiment, the resin component (A), the curing agent component (B) or both components can contain at least one rheology additive.

Suitable rheology additives are (optionally organically post-treated) fumed silica, cellulose or cellulose derivatives such as cellulose esters, alkyl and methyl celluloses, and castor oil derivatives, layered silicates such as laponite, bentonite or montmorillonite, Neuburg Siliceous Earth, fumed silica, polysaccharides, polyacrylate, polyurethane or polyurea thickeners, or mixtures of two or more thereof. Particular preference is given to organically post-treated fumed silica.

The proportion of rheology additive, if present, after mixing components (A) and (B) is preferably about 1 wt % to about 6 wt % relative to the total weight of components (A) and (B), preferably about 1 wt % to about 5 wt %, relative to the total weight of components (A) and (B).

In a preferred embodiment, component (A) and/or component (B) of a two-component resin system according to the invention comprises quartz powder as filler and silica as rheology additive.

### Further Optional Components

Adhesion promoters can also be used to improve crosslinking with the substrate (e.g. a (bore) hole wall).

Suitable adhesion promoters are silanes that have at least one Si-bound hydrolyzable group. Preferred examples are 3-glycidoxypropyltrimethoxysilane, 3-glycidoxypropyltriethoxysilane, 2-(3,4-epoxycyclohexyl)ethyltrimethoxysilane, N-2-(aminoethyl)-3-aminopropylmethyldiethoxysilane, N-2-(aminoethyl)-3-aminopropyltriethoxysilane, 3-aminopropyltrimethoxysilane, 3-aminopropyltriethoxysilane, N-phenyl-3-aminoethyl-3-aminopropyltrimethoxysilane, 3-mercaptopropyltrimethoxysilane, 3-mercaptopropylmethyldimethoxysilane and trimethoxysilylpropyl diethyl tetramine and mixtures thereof. Further suitable silanes are described, for example, in EP 3 000 792 A1.

Furthermore, solvents can be used in the two-component resin system, for example to specifically slow down curing times or change the gel time. Preferred solvents can comprise monohydric, dihydric or polyhydric alcohols, preferably a dihydric alcohol. A polyhydric alcohol is understood here to be a trihydric or higher polyhydric alcohol. Strongly preferred, component (B) may comprise a dihydric alcohol, in particular dipropylene glycol. Alternatively, component (B) can comprise benzyl alcohol.

Wetting agents and dispersants, phlegmatizers, surface additives, plasticizers, such as phthalic acid or sebacic acid esters, wax additives, stabilizers, antistatic agents, flexibilizers, curing catalysts, further control agents for the reaction rate, defoamers & deaerators, viscosity reducers or other process additives can also be added for optimization.

Likewise conceivable are coloring additives such as dyes or pigments, for example for different coloring of the components for better control of their mixing.

### Mixing Ratio of Components (A) and (B)

According to the invention, it is preferred that the curable epoxy resin comprised by component (A) and the at least one tertiary amine comprised by component (B) are present in a non-stoichiometric ratio, wherein the proportion of the at least one tertiary amine in the resin composition arising from mixing the two components (A) and (B) is from about 3 wt % to about 20 wt %, preferably from about 4 to about 15 wt %, more preferably from about 5 to about 10 wt % relative to the at least one curable epoxy resin.

If the curable epoxy resin in component (A) and the at least one tertiary amine in component (B) are present in a non-stoichiometric ratio, the two-component resin system according to the invention can cure particularly quickly. In this way, greater adhesive strengths, high compressive strengths, high glass transition temperatures and reduced creep of the resulting cured system can also be achieved.

The mixture is typically produced in an injection device using a static mixer when the two components (A) and (B) are pressed out of two separate chambers. Therefore, typical mixing ratios of components A:B are about 1:1 (v/v), about 2:1 (v/v), about 3:1 (v/v), about 5:1 (v/v) or about 10:1 (v/v). In a preferred embodiment, the mixing ratio is from about 1;1 (v/v) to about 15:1 (v/V), particularly preferably from about 3:1 (v/v) to about 10:1 (v/V), especially about 3:1 (v/) or about 10:1 (v/v), very particularly preferably about 10:1 (v/V).

### Use

During use according to the invention, the resin component (A) and the curing agent component (B) are mixed using a suitable device, for example a static mixer, as described above, or a dissolver, which results in an epoxy resin composition.

When used as a “chemical anchor”, the mixing is done directly in front of or in a cavity, for example a hole (preferably a borehole) or gap, and the epoxy resin composition is then introduced into the (optionally previously cleaned) hole or the gap by means of a known injection device. The component to be fastened is then inserted into the epoxy resin composition and aligned. The resin composition then cures.

The curing agent component (B) causes the epoxy resin contained in the resin component (A) to cure so that the epoxy resin composition forms a polymer within a desired time at the place of use under ambient conditions, for example at the construction site. In the chemical reaction, the at least one tertiary amine, such as 2,4,6-tris(dimethylaminomethyl)phenol, has the role and function of an accelerator. This chemical reaction is further a function of the temperature, the moisture in the surroundings and the substrate, the chemical composition of the substrate, and of the further constituents of components (A) and (B). Environmental conditions can vary, for example low temperatures (e.g., −5° C.) or high temperatures (e.g., 40° C.) during the night-day cycles.

In one embodiment, the resin composition cures at an ambient temperature of about 10° C. to about 35° C., preferably from about 20° C. to about 30° C. In another embodiment, the resin composition cures at an elevated ambient temperature of about 30° C. to about 90° C., preferably of about 40° C. to about 80° C.

As described above, the curing reaction can be influenced by several factors and can therefore take several hours to several days. Typically, the curing reaction can take between about 24 hours and about 72 hours. Preferably, can be fully cured after a curing time of around 48 hours.

According to the invention, a two-component resin system as described herein is preferably used for construction purposes. The expression “for construction purposes” means the structural adhesion of, in particular, concrete/concrete, steel/concrete or steel/steel or of one of said materials with other mineral materials, to the structural strengthening of components made of concrete, brickwork and other mineral materials, to the reinforcement of buildings with fiber-reinforced polymers, to the chemical fastening on or in surfaces made of concrete, steel or other mineral materials, in particular the chemical fastening of construction elements and anchoring means, such as anchor rods, anchor bolts, (threaded) rods, (threaded) sleeves, rebar, screws and the like, in cavities, in particular in (bore) holes or gaps in various substrates such as (reinforced) concrete, brickwork, other mineral materials, metals (e.g., steel), ceramics, plastics, glass, and wood.

A two-component resin system with the at least one tertiary amine is very particularly preferred for chemically fastening anchoring elements in a hole (in particular a borehole) or gap in a substrate (in particular a building substrate).

The ambient temperature can fluctuate over the course of the lifetime of a chemical anchor after it has cured. Typically, the ambient temperature is from about −10° C. to about 60° C., preferably from about-5° C. to about 50° C., more preferably from about 0° C. to about 40° C. For example, the ambient temperature can be around 30° C.

However, the substrate temperature can be correspondingly higher which is usually the case in the construction sector if there is strong solar radiation or an external heat source.

A use according to the invention is preferably carried out at a substrate temperature of about 30° C. to about 90° C., preferably about 35° C. to about 85° C., more preferably from about 40° C. to about 80° C., and even more preferably from about 45° C. to about 75° C. At such a substrate temperature, the use of the at least one tertiary amine can improve the creep behavior.

In a preferred embodiment, after curing, the chemical anchor is capable of temporarily or permanently bearing loads at a substrate temperature of about 30° C. to about 90° C.

### PREFERRED EMBODIMENTS

Preferred embodiments of the invention have the following features with respect to component (A), component (B), and the resin composition which is produced by mixing component (A) and (B):

### Component (A):

In a preferred embodiment, component (A) of a two-component resin system used according to the invention comprises bisphenol F diglycidyl ether and bisphenol A diglycidyl ether.

In a more strongly preferred embodiment, component (A) of a two-component resin system used according to the invention comprises bisphenol F diglycidyl ether and bisphenol A diglycidyl ether, as well as 1,4-butanediol diglycidyl ether, trimethylolpropane triglycidyl ether, quartz powder and silica.

In a particularly preferred embodiment, the component (A) of a two-component resin system used according to the invention comprises from about 20 to about 40 wt % bisphenol F diglycidyl ether, from about 10 to about 25 wt % bisphenol A diglycidyl ether, and from about 2 to about 10 wt % 1,4-butanediol diglycidyl ether, from about 4 to about 8 wt % trimethylolpropane triglycidyl ether, from about 25 to about 55 wt % quartz powder and from about 2 to about 4 wt % silica, relative to the total weight of component (A).

### Component (B):

In a preferred embodiment, the component (B) comprises from about 30 to about 70 wt % 2,4,6-tris(dimethylaminomethyl)phenol relative to the total weight of component (B).

In a further preferred embodiment, the component (B) of a two-component resin system used according to the invention comprises from about 25 to about 55 wt % quartz powder and from about 2 to about 6 wt % silica relative to the total weight of component (B).

In a particularly preferred embodiment, the component (B) comprises from about 30 to about 70 wt % 2,4,6-tris(dimethylaminomethyl)phenol, from about 25 to about 55 wt % quartz powder and from about 2 to about 6 wt % silica relative to the total weight of component (B).

### Components A+B:

The combinations of the epoxy resins, reactive diluents, rheology additives and fillers with 2,4,6-tris(dimethylaminomethyl)phenol, which are used in the example compositions, in particular in the proportionate weights used there, are very particularly preferred as constituents of a two-component resin system used according to the invention and very particularly preferred in combination with the other constituents of components (A) and (B) used there. Most preferred are those compositions of components (A) and (B) which are described in the examples.

In a particularly preferred embodiment, the component (A) and the component (B) of a two-component resin system used according to the invention are mixed in a mixing ratio of A:B of about 10:1 (v/v), wherein the component (A) comprises from about 20 to about 40 wt % bisphenol F diglycidyl ether, from about 10 to about 25 wt % bisphenol A diglycidyl ether, and from about 2 to about 10 wt % 1,4-butanediol diglycidyl ether, from about 4 to about 8 wt % trimethylolpropane triglycidyl ether, from about 25 to about 55 wt % quartz flour, and from about 2 to about 4 wt % silica relative to the total weight of component (A); and wherein component (B) comprises from about 30 to about 70 wt % 2,4,6-tris(dimethylaminomethyl)phenol, from about 25 to about 55 wt % quartz flour, and from about 2 to about 6 wt % silica relative to the total weight of component (B).

The invention is described in greater detail below in reference to embodiments which, however, should not be understood in a restrictive sense.

### DESCRIPTION OF THE FIGURES

FIG. 1 shows the graphical representation of Log (G′), Log (G″) and Tan (delta) from DMTA measurements (comparative examples in bold).

FIG. 2 shows the displacement due to creep at 43° C.

### EXEMPLARY EMBODIMENTS

### Preparation of Components (A) and (B)

The constituents of components (A) and (B) used are listed in Table 1.

TABLE 1
Constituents used

| | | Trade name | | |
|---|---|---|---|---|
| Constituent | Function | or CAS | Manufacturer | Country |
| Bisphenol F-based | Epoxy resin | Araldite GY 282 | Huntsman | Belgium |
| epoxy resin | | | | |
| Bisphenol A-based | Epoxy resin | Araldite GY 240 | Huntsman | Belgium |
| epoxy resin | | | | |
| 1,4-butanediol | Reactive | Araldite ® DY-026 | Huntsman | Belgium |
| diglycidyl ether | diluent | | | |
| Trimethylolpropane | Reactive | Araldite DY-T | Huntsman | Belgium |
| triglycidyl ether | diluent | | | |
| m-xylylenediamine | Primary | 1477-55-0 | MGC | Japan |
| (mXDA) | amine | | | |
| 2,4,6- | Accelerator | Ancamine ® K54 | Air | Netherlands |
| tris(dimethylamino | (tertiary | | Products | |
| methyl)phenol | amine) | | | |
| Calcium nitrate | Accelerator | 13477-34-4 | Sigma- | Germany |
| tetrahydrate | | | Aldrich | |
| (Ca(NO₃)₂ × 4 H₂O) | | | | |
| Glycerol | Solvent | 56-81-5 | Merck | Germany |
| Quartz powder | Filler | Millisil ® W12 | Quarzwerke | Germany |
| | | | Frechen | |
| Silica | Rheology | Cab-O-Sil ® TS- | Cabot | Germany |
| | additive | 720 | Rheinfelden | |

To prepare the resin component (A), the liquid constituents thereof were first mixed with a wooden spatula. Quartz flour and silica were added and then stirred, first manually with the wooden spatula and then in a dissolver (PC Laborsystem, volume 1 L) at 80 mbar at 3500 rpm for 8.5 min.

For comparative examples 1 and 2, an 80% solution of calcium nitrate in glycerol was used. For this purpose, 400 g Ca(NO₃)₂ tetrahydrate was added to 100 g glycerol and stirred at 50° C. for about 3 hours until the salt was completely dissolved.

To prepare the curing agent component (B), m-xylylenediamine (mXDA) and/or 2,4,6-tris(dimethylaminomethyl)phenol were first added to a plastic bucket. For comparative examples 1 and 2, the calcium nitrate solution was added and mixed manually with the wooden spatula. Thereafter, the quartz powder and the silica were added to the resulting mixture and stirred in a dissolver (PC Laborsystem, volume 1 liter) at 80 mbar and 3500 rpm for 8.5 min.

### Preparation for the Use of Components (A) and (B)

For the comparative examples 1 and 2, the components (A) and (B) were mixed together for 30 seconds shortly before their use using a speed mixer (Hauschild, Hamm) in the ratio shown in Table 2 below. For use as a chemical anchor, the resulting mixture was filled into a 1-component cartridge immediately after mixing. This was injected from the 1-component cartridge through a nozzle directly into the borehole.

For the example according to the invention, the components (A) and (B) were filled into a hard cartridge with the desired mixing ratio (10:1 (v/v)). For injection into the borehole, a static mixer was connected to the hard cartridge, and the epoxy resin mixture was dosed using a dispenser. The epoxy resin mixture was injected after the disposal of the first three pull-offs to ensure proper mixing of both components.

### Measurement Methods for Characterizing the Two-Component Resin Systems

Pull-Out Tests from Concrete

In accordance with EAD 330499-01-0601, boreholes with a diameter of 14 mm were first drilled into a horizontal concrete slab (C20/25) using a hammer drill. The boreholes were cleaned (2× blowing out with 6 bar compressed air, 2× brushing, 2× blowing out with 6 bar compressed air). Subsequently, the boreholes were filled to two thirds full from the bottom of the borehole with the respective epoxy resin composition to be tested, which was prepared as described above from the respective components (A) and (B). A steel threaded rod (M12) was pressed into the borehole by hand to an embedment depth of 60 mm. The excess epoxy resin composition was removed by means of a spatula. Curing took place at the temperature and for the time specified for the respective test. The threaded rod was then pulled out until failure while measuring the tensile strength (in MPa). The tensile strength was determined three times in each case and the standard deviation (SD) calculated.

### Compressive Strength

The samples were prepared as described above for the pull-out tests and cured as described below in the respective test. Curing was carried out in a PE pipe with an internal diameter of 6 mm. The samples were then cut to a length of 10 mm (plane-parallel surfaces). The samples were conditioned for 5 days at 23° C. and 50% relative humidity. The determination of the compressive strength and the associated modulus of elasticity was carried out in accordance with DIN EN ISO 604:2003-12 at a test speed of 1 mm/min. The measurement was carried out using a testing machine from Zwick Roell.

### Thermomechanical Analysis (DMTA, Dynamic Mechanical Thermal Analysis)

To determine the thermomechanical properties of a cured epoxy resin mixture, sample cylinders having a diameter of 1 cm and a length of 5 cm were produced. The epoxy resin mixture was pressed into a PE pipe with an internal diameter of 6 mm and cured for 24 hours at 25° C. The PE pipe filled with the now cured epoxy resin mixture was then cut into 5 cm long pieces, after which the epoxy resin cylinders were pressed out of the PE pipe. The cylinders were then stored in a temperature-controlled chamber at 23° C. and 50% relative humidity for 5 days before being measured with a HAAKE MARS rheometer.

In the subsequent DMTA experiments, the storage modulus (G′), the loss modulus (G″) and the loss angle tan delta (δ) were determined as a function of temperature in accordance with DIN EN ISO 6721-11:2019-06. From the obtained curves, the glass transition temperature (Tg) could be determined from the peak in the loss modulus curve.

### Creep Behavior

The samples were prepared as described above for the extraction tests and cured at 23° C. for 24 hours. After subsequent storage for 24 hours at 43° C., creep tests were also carried out at 43° C. To investigate the creep behavior, a creep test was carried out as described above in accordance with EAD 330499-01-0601 with a permanent load of 21 kN, and the displacement of the threaded rod was measured over time.

### Results

Table 2 lists the proportions of the individual constituents in components (A) and (B) in (comparative) examples 1 and 2 in percent by weight (wt %).

TABLE 2
(Comparative) examples 1 and 2

| | | Examples (parts by weight in wt %) | | | |
|---|---|---|---|---|---|
| | | Comparative | Comparative | | |
| Constituents | Function | Example 1 | example 2 | Example 1 | Example 2 |
| Component (A) | | | | | |
| Bisphenol A- | Epoxy resin | 35 | 35 | 35 | 25.3 |
| based epoxy resin | | | | | |
| Bisphenol F- | Epoxy resin | 18.8 | 18.8 | 18.8 | 13.6 |
| based epoxy resin | | | | | |
| 1,4-butanediol | Reactive | 6.7 | 6.7 | 6.7 | 4.9 |
| diglycidyl ether | diluent | | | | |
| Trimethylolpropane | Reactive | 6.7 | 6.7 | 6.7 | 4.9 |
| triglycidyl ether | diluent | | | | |
| Quartz powder | Filler | 30 | 30 | 30 | 48.7 |
| Silica | Rheology | 2.7 | 2.7 | 2.7 | 2.7 |
| | additive | | | | |
| Total | | 100 | 100 | 100 | 100 |
| Component (B) | | | | | |
| 2,4,6-tris(dimethyl- | Accelerator | 0 | 5 | 62.4 | 41 |
| laminomethyl) | | | | | |
| phenol | | | | | |
| mXDA | Primary | 36.8 | 36.8 | 0 | 0 |
| | amine | | | | |
| Ca(NO₃)₂ (80% in | Accelerator | 1.9 | 1.9 | 0 | 0 |
| glycerol) | | | | | |
| Quartz powder | Filler | 57.3 | 52.3 | 32.6 | 54 |
| Silica | Rheology | 4 | 4 | 5 | 5 |
| | additive | | | | |
| Total | | 100 | 100 | 100 | 100 |
| Component (A) and (B) | | | | | |
| Ratio A:B (v/v) | | 3:1 | 3:1 | 10:1 | 10:1 |
| 2,4,6-tris(dimethyl- | | 0 | 1.4 | 5.2 | 3.6 |
| laminomethyl) | | | | | |
| phenol/total (wt %) | | | | | |
| 2,4,6-tris(dimethyl- | | 0 | 3.6 | 10.8 | 10.4 |
| laminomethyl) | | | | | |
| phenol/epoxy | | | | | |
| resin (wt %) | | | | | |

The epoxy resin mixtures of examples 1 and 2 and of comparative examples 1 and 2 were prepared from components (A) and (B) according to Table 2. The extraction tests described above were then carried out. For this purpose, the epoxy resin mixtures were first cured for 24 h at 25° C. and then for 24 h at 80° C. The tensile strength of the cured chemical anchors was determined as described above.

Table 3 shows the measurement results for comparative examples 1 and 2 as well as examples 1 and 2. The tensile strength of all tested chemical anchors was at the same level. From this, it can be concluded that chemical anchors prepared according to the invention can achieve equally high tensile strengths as chemical anchors prepared from epoxy-amine systems with primary amines described in the prior art. Furthermore, the result shows that a high proportion of 2,4,6-tris(dimethylaminomethyl)phenol, as in example 1, has a comparable tensile strength to a chemical anchor with a lower proportion of 2,4,6-tris(dimethylaminomethyl)phenol.

TABLE 3
Measurement results of the concrete pull-out tests

| | Compar | Compar- | | |
|---|---|---|---|---|
| | ative | ative | Exam- | Exam- |
| | example 1 | example 2 | ple 1 | ple 2 |
| Curing: 24 h at 25° C., then | 21 | 23 | 21 | 21 |
| 24 h at 80° C. (in MPa) | | | | |

The compressive strength was determined as described above for comparative example 1 and example 1. To measure the compressive strength, the chemical anchors were cured for 5 days at 25° C.

The test results for compressive strength in Table 4 show an improvement in the compressive strength in example 1 with a proportion of 2,4,6-tris(dimethylaminomethyl)phenol according to the invention in contrast to comparative example 1 without 2,4,6-tris(dimethylaminomethyl)phenol.

TABLE 4
Compressive strength determined by concrete pull-out tests

| | Compressive strength | Modulus of elasticity |
|---|---|---|
| | [MPa] | (pressure) [GPa] |
| Comparative Example 1 | 103 | 2.5 |
| Example 1 | 114 | 4.9 |

Both the compressive strength and the modulus of elasticity are significantly higher in example 1 than in comparative example 1.

In order to determine the mechanical properties at elevated temperatures, DMTA experiments were carried out with chemical anchors produced according to comparative example 2 and example 1 according to the invention, as described above.

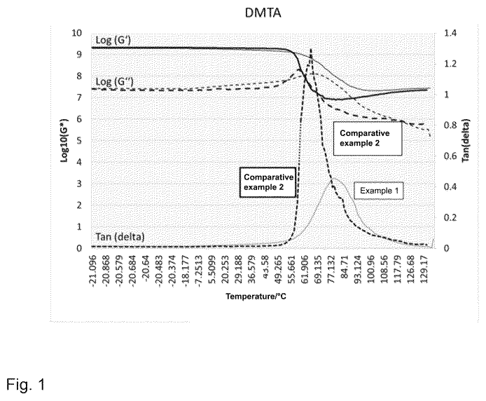

From the DMTA data (see FIG. 1), the glass transition temperature Tg was determined as the maximum of the tan (delta). It was 66° C. for comparative example 2 and 80° C. for example 1 according to the invention, see Table 5. Example 1 showed a higher Tg and a later G′ in the measurement. These are advantageous when the cured epoxy resin mixture is used as a chemical anchor at elevated temperature since these data imply that the chemical anchor can withstand higher loads at an elevated substrate temperature, such as above about 30° C., especially above about 40° C. This increased glass transition temperature Tg can be attributed to the proportion of 2,4,6-tris(dimethylaminomethyl)phenol according to the invention.

TABLE 5
Glass transition temperature determined by DMTA measurements

| | Tg from DMTA tan(delta) max/° C. |
|---|---|
| Comparative example 2 | 66 |
| Example 1 | 80 |

To investigate the creep behavior of the chemical anchor at elevated temperatures, the chemical anchors were prepared as described in the pull-out tests and cured at 23° C. for 24 hours. After a further 24 hours of storage at 43° C., the creep tests were carried out with a sustained load of 21 KN as described above. Two chemical anchors produced according to example 1 and two chemical anchors produced according to example 2 were compared.

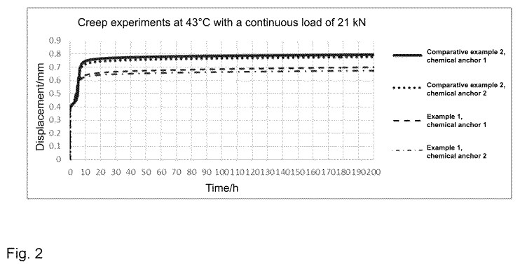

The observed creep-induced displacement of the chemical anchors over time is shown in FIG. 2. In the first hours, a stronger displacement, the so-called primary creep, takes place, wherein a stationary phase, the so-called secondary creep, sets in after about 8 hours. The measurement of the displacement was continued for 200 hours, wherein a plateau of the displacement curve was reached. The displacement after 8 h was used for the evaluation in a comparative assessment of the chemical anchors. Both chemical anchors of example 1 according to the invention demonstrated less displacement than those of comparative example 2.

These results show that the creep, given use at elevated temperature, was lower for the example with a high amount of 2,4,6-tris(dimethylaminomethyl)phenol than for the comparative example with a low amount of 2,4,6-tris(dimethylaminomethyl)phenol. Thus, a certain amount of 2,4,6-tris(dimethylaminomethyl)phenol is essential to the invention in order to reduce the creep of a chemical anchor.

1. A method, comprising:
reducing, with the use of at least one tertiary amine, the creep behavior of a cured chemical anchor at a substrate temperature of about 30° C. to about 90° C. as compared to a chemical anchor having a lower amount or no amount of the at least one tertiary amine,
wherein the cured chemical anchor was prepared by mixing a resin component (A) and a curing agent component (B) of a two-component resin system and then curing, wherein the two-component resin system comprises:
the resin component (A) comprising at least one curable epoxy resin, and
the curing agent component (B) comprising the at least one tertiary amine,
wherein the at least one tertiary amine is selected from the group consisting of 2,4,6-tris[(di(C₁-C₆-alkyl)amino-(C₁-C₆-alkylidene)]phenols, 1,3,5-tris[(di(C₁-C₆-alkyl)amino-(C₁-C₆-alkylidene)]hexahydro-1,3,5-triazines and any mixtures of two or more thereof,
wherein a proportion of the at least one tertiary amine in a resin composition arising by mixing the two components (A) and (B) is from about 3 wt % to about 20 wt % relative to the at least one curable epoxy resin, and
wherein the two-component resin system comprises no primary and no secondary amine.

2. The method according to embodiment 1, wherein the substrate temperature is from about 35° C. to about 85° C.

3. A method, comprising:
chemically fastening, with the use of a two-component resin system as a chemical anchor, a structural element or an anchor in a cavity in a substrate,
wherein the two-component resin system comprises:
a resin component (A) comprising at least one curable epoxy resin, and
a curing agent component (B) comprising at least one tertiary amine,
wherein components (A) and (B) are mixed before use which results in a resin composition,
wherein the proportion of the at least one tertiary amine in the resin composition arising by mixing the two components (A) and (B) is from about 3 wt % to about 20 wt % relative to the at least one curable epoxy resin,
wherein the at least one tertiary amine is selected from the group consisting of 2,4,6-tris[(di(C₁-C₆-alkyl)amino-(C₁-C₆-alkylidene)]phenols, 1,3,5-tris[(di(C₁-C₆-alkyl)amino-(C₁-C₆-alkylidene)]hexahydro-1,3,5-triazines and any mixtures thereof,
wherein the two-component resin system comprises no primary and no secondary amine.

4. The method according to embodiment 1, wherein the at least one tertiary amine is selected from the group consisting of 2,4,6-tris[(di(C₁-C₆-alkyl)amino-(C₁-C₆-alkylidene)]phenols, 1,3,5-tris[3-(dimethylamino)propyl]-hexahydro-1,3,5-triazine and any mixtures of two or more thereof.

5. The method according to embodiment 1, wherein the at least one tertiary amine is selected from the group consisting of 2,4,6-tris(dimethylaminomethyl)phenol and 1,3,5-tris[3-(dimethylamino)propyl]hexahydro-1,3,5-triazine and any mixtures thereof.

6. The method according to embodiment 1, wherein the proportion of the at least one tertiary amine in the resin composition arising by mixing the two components (A) and (B) is from about 4 wt % to about 15 wt %, relative to the at least one curable epoxy resin.

7. The method according to embodiment 1, wherein the at least one curable epoxy resin is a compound selected from the group consisting of glycidyl ethers of polyhydric phenols having a glycidyl group functionality of about 1.5 or greater and epoxidized vegetable oils, and mixtures of two or more thereof.

8. The method according to embodiment 1, wherein the at least one curable epoxy resin, after mixing components (A) and (B), is present in about 30 wt % to about 70 wt % relative to the total weight of components (A) and (B).

9. The method according to embodiment 1, wherein the two-component resin system additionally comprises at least one reactive diluent, wherein the reactive diluent is contained in the resin component (A).

10. The method according to embodiment 1, wherein the two-component resin system additionally comprises at least one filler, wherein the at least one filler is contained either in the resin component (A) or in the curing agent component (B) or in both components (A) and (B).

11. The method according to embodiment 10, wherein the at least one filler is selected from the group consisting of quartz sand, glass, corundum, porcelain, earthenware, barite, feldspar, blast furnace slag, gypsum, cement, talc, fly ash, limestone, and any mixtures of two or more thereof.

12. The method according to embodiment 10, wherein the at least one filler, after mixing the components (A) and (B), is present in about 10 wt % to about 55 wt % relative to the total weight of the components (A) and (B).

13. The method according to embodiment 1, wherein the two-component resin system additionally comprises at least one thixotropic agent, wherein the at least one thixotropic agent is contained either in the resin component (A) or in the curing agent component (B) or in both components (A) and (B), and wherein the at least one thixotropic agent is selected from the group consisting of organically post-treated fumed silica, bentonites, alkyl and methyl celluloses and castor oil derivatives, and any mixtures of two or more thereof.

14. The method according to embodiment 13, wherein the at least one thixotropic agent, after mixing components (A) and (B), is present in about 1 wt % to about 6 wt % relative to the total weight of components (A) and (B).

15. The method according to embodiment 1, wherein the two components (A) and (B) are initially present in two separate chambers of an injection system and, immediately prior to their use, are squeezed out of the respective chambers and mixed via a static mixer, wherein the resulting resin composition is thereby injected from a tip of the static mixer into a hole or gap in the substrate for subsequent curing.

16. The method according to embodiment 3 for chemically fastening a structural element or an anchor selected from the group consisting of anchor rods, anchor bolts, threaded rods, threaded sleeves, reinforced concrete rods, reinforcing bars and screws in a substrate selected from the group consisting of concrete, masonry, steel, ceramics, plastics, glass, wood, and any combinations thereof.
